(19) United States
(12) Patent Application Publication
(10) Pub. No.: US 2008/0136145 A1
(43) Pub. Date: Jun. 12, 2008

(54) Airbag door of airbag for front passenger seat for vehicle

(76) Inventor: Byung Seok Kong, Gunpo-si (KR)

Correspondence Address: MORGAN, LEWIS & BOCKIUS LLP;COUNSELORS AT LAW, 2 Palo Alto Square, 3000 El Camino Real, Suite 700, Palo Alto, CA, 94306, US

(21) Appl. No.: 11/726,193

(22) Filed: Mar. 21, 2007

(30) Foreign Application Priority Data
Dec. 7, 2006 (KR) 10-2006-0124140

(51) Int. Cl. B60R 21/20

(52) U.S. Cl. 280/728.3

(57) ABSTRACT

An apparatus for housing an airbag, disposed at a crash pad of a vehicle. A pad deploy part includes a stepped portion, a first hinge, and a tear groove. An airbag door, attached to the pad deploy part, includes a second hinge integral to the first hinge, and a chute part connected to an airbag housing. Deployment of the airbag tears the tear groove such that the pad deploy part and airbag door rotate around the first and second hinges, respectively. The airbag door may be attached to the pad deploy part only between the first hinge and the stepped part. The first hinge may be thicker than the second hinge. The apparatus may further include a mount hole on the chute part, configured to be coupled with a hook on the airbag housing.

### CROSS-REFERENCE TO RELATED APPLICATION

This application claims priority to, and the benefit of, Korean Patent Application No. 10-2006-0124140, filed in the Korean Intellectual Property Office on Dec. 7, 2006, the entire contents of which are incorporated herein by reference.

### BACKGROUND OF THE INVENTION

(a) Field of the Invention

The present invention relates to an airbag door of an airbag for a front passenger seat of a vehicle.

(b) Description of the Related Art

A conventional airbag for a front passenger seat is housed in an airbag housing within a crash pad. A door plate is mounted to the crash pad, and includes a rotation part, a chute for coupling the airbag housing to the crash pad, and a door cover disposed in front of the crash pad. The chute is bolted to an end of the door plate.

During deployment, the airbag applies pressure to the door plate, and a tear line on the door cover is torn so that the airbag deploys through the door. However, the rotation part may not allow sufficient rotation of the door plate. The door cover may therefore be torn, and the broken pieces may hit the passenger in the front passenger seat. The layout of the rotation part should be changed so the door cover does not interfere with the other parts.

### SUMMARY OF THE INVENTION

Exemplary embodiments of the present invention provide an apparatus for housing an airbag, disposed at a crash pad of a vehicle. A pad deploy part includes a stepped portion, a first hinge, and a tear groove. An airbag door, attached to the pad deploy part, includes a second hinge integral to the first hinge, and a chute part connected to an airbag housing. Deployment of the airbag tears the tear groove such that the pad deploy part and airbag door rotate around the first and second hinges, respectively.

The airbag door may be attached to the pad deploy part only between the first hinge and the stepped part. The first hinge may be thicker than the second hinge. The apparatus may further include a mount hole on the chute part, configured to be coupled with a hook on the airbag housing.

### BRIEF DESCRIPTION OF THE DRAWINGS

FIG. 1 shows an airbag door according to an exemplary embodiment of the present invention.

FIG. 2A to FIG. 2C show a method of manufacturing the airbag door of FIG. 1.

### DETAILED DESCRIPTION OF THE PREFERRED EMBODIMENTS

An exemplary embodiment of the present invention will hereinafter be described in detail with reference to the accompanying drawings.

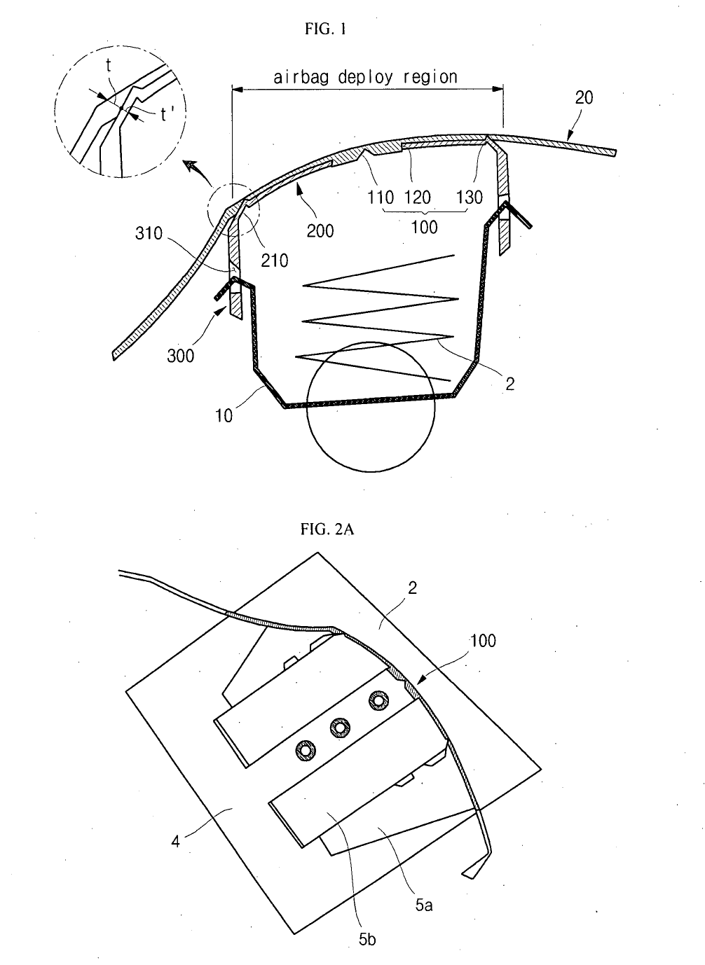

Referring to FIG. 1, in an exemplary embodiment of the present invention, a pad deploy part 100 is provided in an airbag deploy region of a crash pad 20 of a vehicle. The pad deploy part 100 includes stepped parts 120 at both sides of a tear groove 110. First hinges 130 are provided opposite the stepped parts 120. An airbag door includes an airbag door part 200, integral to a lower part of the pad deploy part 100. The airbag door part 200 and pad deploy part 100 may be injection molded. A second hinge 210 is integral to the first hinge 130. A chute part 300 extends inward and is connected to an airbag housing 10.

The tear groove 110 has a depth sufficient for it to be smoothly torn by the expansion force of the airbag 2.

The pad deploy part 100 may be made of powder phenol-formaldehyde (PPF) resin, and the airbag door part 200 may be made of ThermoPlastic Olefin (TPO) material having high softness. Temperature fluctuations will thus have a small impact on the material properties of the airbag door part 200.

The airbag door part 200 is integrated with the pad deploy part 100 only between the first hinge 130 and the stepped part 120.

The first hinge 130 is thicker than the second hinge 210.

A mount hole 310 is provided on the chute part 300 for coupling with a hook at the outer end of the airbag housing 10.

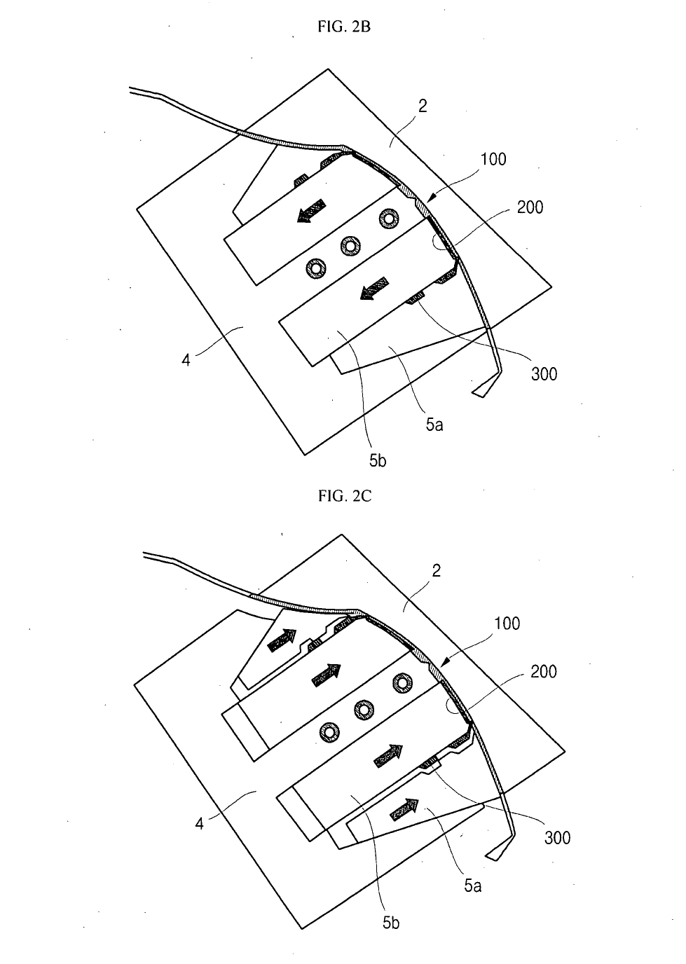

A method of manufacturing an airbag door according to an exemplary embodiment of the present invention will be explained with reference to FIGS. 2A-2C.

Referring to FIG. 2A, material is injected to the pad deploy part 100 through an injector (not shown) with upper and lower molds 2 and 4 coupled to one another, so as to form the pad deploy part 100. First and second slide molds 5a and 5b closely adhere to the region of the first hinge 130, so that the PPF resin does not permeate the first hinge 130.

Referring to FIG. 2B, the second slide mold 5b is withdrawn in the direction of the arrows, by a distance corresponding to a distance at which the airbag door part 200 is formed. Material of the airbag door part 200 is then injected.

If material of the pad deploy part 100 and material of the airbag door part 200 and the chute part 300 are injected into the upper and the lower molds 2 and 4 with a time interval therebetween, firm bonding takes place at a boundary region where the pad deploy part 100 and the airbag door part 200 surface-contact. In addition, directions of the first and the second slide molds 5a and 5b coincide with an angle of extraction of the mold, so manufacturing is easily performed.

Referring to FIG. 2C, if the upper and the lower molds 2 and 4 are withdrawn and the first and the second slide molds 5a and 5b are moved in the direction of the arrows, a side under cut part of the chute part 300 is smooth, and the product can be easily taken out. In addition, a space for cooling water is provided by the stepped part 120.

Operation of an airbag door will now be described, referring to FIG. 1. In a collision, a detection sensor (not shown) equipped to a vehicle detects the impact and instructs the airbag 2 to deploy. The airbag 2 applies force to the lower parts of the airbag door part 200 and the pad deploy part 100.

The tear groove 110 of the pad deploy part 100 is torn, and the airbag door part 200 is deformed. The airbag door part 200 and the pad deploy part 100 swing outward around the first hinge 130 and the second hinge 210. The thickness t of the first hinge 130 is thicker than the thickness t′ of the second hinge 210.

When the pad deploy part 100 and the airbag door part 200 are fully open, they are not torn.

As described above, the inventive airbag door is not broken so that a passenger occupying the front passenger seat is not injured by the door. In addition, the number of parts is small, reducing manufacturing cost and weight.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for housing an airbag, disposed at a crash pad of a vehicle and comprising:
a pad deploy part comprising a stepped portion, a first hinge, and a tear groove; and
an airbag door attached to the pad deploy part and comprising a second hinge integral to the first hinge, and a chute part configured to be connected to an airbag housing;
wherein deployment of the airbag tears the tear groove such that the pad deploy part and airbag door rotate around the first and second hinges, respectively.

2. The apparatus of claim 1, wherein the airbag door is attached to the pad deploy part only between the first hinge and the stepped part.

3. The apparatus of claim 1, wherein the first hinge is thicker than the second hinge.

4. The apparatus of claim 1, further comprising a mount hole on the chute part, configured to be coupled with a hook on the airbag housing.
